(19) United States
(12) Patent Application Publication
(10) Pub. No.: US 2014/0014421 A1
(43) Pub. Date: Jan. 16, 2014

(54) THERMAL MANAGEMENT OF ELECTRIC VEHICLE BATTERY PACK IN THE EVENT OF FAILURE OF BATTERY PACK HEATER

(71) Applicants: Neil Carpenter, Clarkston, MI (US); Guangning Gao, Rochester Hills, MI (US); Ibrahim Alkeilani, Auburn Hills, MI (US)

(72) Inventors: Neil Carpenter, Clarkston, MI (US); Guangning Gao, Rochester Hills, MI (US); Ibrahim Alkeilani, Auburn Hills, MI (US)

(21) Appl. No.: 13/937,382

(22) Filed: Jul. 9, 2013

Related U.S. Application Data
(60) Provisional application No. 61/670,223, filed on Jul. 11, 2012.

(51) Int. Cl. H01M 10/50; B60L 11/18

(52) U.S. Cl. CPC H01M 10/5006; B60L 11/1875
USPC 180/65.1; 429/62; 237/28; 432/9

(57) ABSTRACT

A thermal management system is provided for a vehicle having an electric traction motor and a battery pack. The thermal management system includes a battery pack heater configured to transfer heat to the battery pack, a second thermal load heater configured to transfer heat to a second thermal load, and a control system. The second thermal load heater is selectively thermally connectable to the battery pack to transfer heat from the second thermal load heater to the battery pack. When the vehicle is connected to an external energy source and the battery pack is at sufficiently low temperature, the control system is configured to control the temperature of the battery pack by activating the second thermal load heater and thermally connecting the second thermal load heater to the battery pack in response to a failure of the battery pack heater.

### CROSS-REFERENCE TO RELATED APPLICATIONS

The present application claims the benefit of U.S. Provisional Application No. 61/670,223 filed Jul. 11, 2012. The entire disclosure of the above application is incorporated herein by reference.

### TECHNICAL FIELD

The present disclosure generally relates to vehicles having an electric traction motor and a battery pack. More particularly, the present disclosure relates to a thermal management system for the battery pack in electric vehicles.

### BACKGROUND

This section provides background information related to the present disclosure which is not necessarily prior art.

Electric vehicles have the potential to transport people and cargo with reduced emissions, as compared to vehicles that are powered solely by internal combustion engines. The term ‘electric vehicle’ as used herein denotes a vehicle that includes an electric traction motor (which may be referred to simply as an ‘electric motor’ for convenience). An electric vehicle may also include an internal combustion engine, or alternatively it may lack an internal combustion engine.

However, the battery pack that is carried by an electric vehicle can be sensitive to certain environmental conditions. For example, if the battery pack is very cold and an attempt is made to charge it (e.g. when it is plugged in to an external power source), the battery pack can be undergo permanent change and can have a reduced operating life as a result.

As noted above, a problem can occur if an electric vehicle is in a state wherein the battery pack of the vehicle is too cold to receive current from an external charging source without impacting battery pack performance and life. To overcome this, some electric vehicles include a battery pack heater and a control system that prevents the battery pack from receiving charge until it has warmed up to a minimum threshold temperature. If the battery pack heater were to fail, however, such a control system algorithm may leave the driver of the vehicle stranded when they next enter the vehicle expecting it to be charged.

### SUMMARY

This section provides a general summary of the disclosure, and is not a comprehensive disclosure of its full scope or all of its features.

In accordance with one aspect of the present disclosure, a thermal management system is provided for a vehicle having an electric traction motor for moving the vehicle, a battery pack configured to provide power for driving the electric traction motor. The thermal management system includes a battery pack heater configured to transfer heat to the battery pack, a second thermal load heater configured to transfer heat to a second thermal load, and a control system. The second thermal load heater is selectively thermally connectable to the battery pack to transfer heat from the second thermal load heater to the battery pack. When the vehicle is connected to an external energy source and the battery pack is at sufficiently low temperature, the control system is configured to control the temperature of the battery pack by activating the second thermal load heater and thermally connecting the second thermal load heater to the battery pack in response to a failure of the battery pack heater.

In accordance with another aspect of the present disclosure, a vehicle is provided that includes a body, a plurality of wheels, an electric traction motor configured to drive at least one of the wheels, a battery pack configured to provide power to drive the electric-traction motor, a battery pack heater configured to transfer heat to the battery pack, a second thermal load heater and a control system. The second thermal load heater is configured to transfer heat to a second thermal load. The second thermal load heater is selectively thermally connectable to the battery pack to transfer heat from the second thermal load heater to the battery pack. When the vehicle is connected to an external energy source and the battery pack is at sufficiently low temperature, the control system is configured to control the temperature of the battery pack by activating the second thermal load heater and thermally connecting the second thermal load heater to the battery pack in response to a failure of the battery pack heater.

In accordance with yet another aspect of the present disclosure, a method is provided for controlling the temperature of a battery pack of a vehicle having an electric traction motor, the method comprising: heating the battery pack with a battery pack heater while the vehicle is connected to an external energy source; and heating the battery pack with a second thermal load heater that is positioned to heat a second thermal load in response to detecting a failure of the battery pack heater.

These and other aspects and features of the non-limiting embodiments may now become apparent to those skilled in the art upon review of the following detailed description of various exemplary embodiments with the accompanying drawings.

### BRIEF DESCRIPTION OF THE DRAWINGS

The non-limiting embodiments may be more fully appreciated by reference to the following detailed description of non-limiting embodiments when taken in conjunction with the accompanying drawings, in which:

FIG. 1 is a side elevation view of an electric vehicle; and

FIG. 2 depicts a schematic representation of a thermal management system for the electric vehicle shown in FIG. 1.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

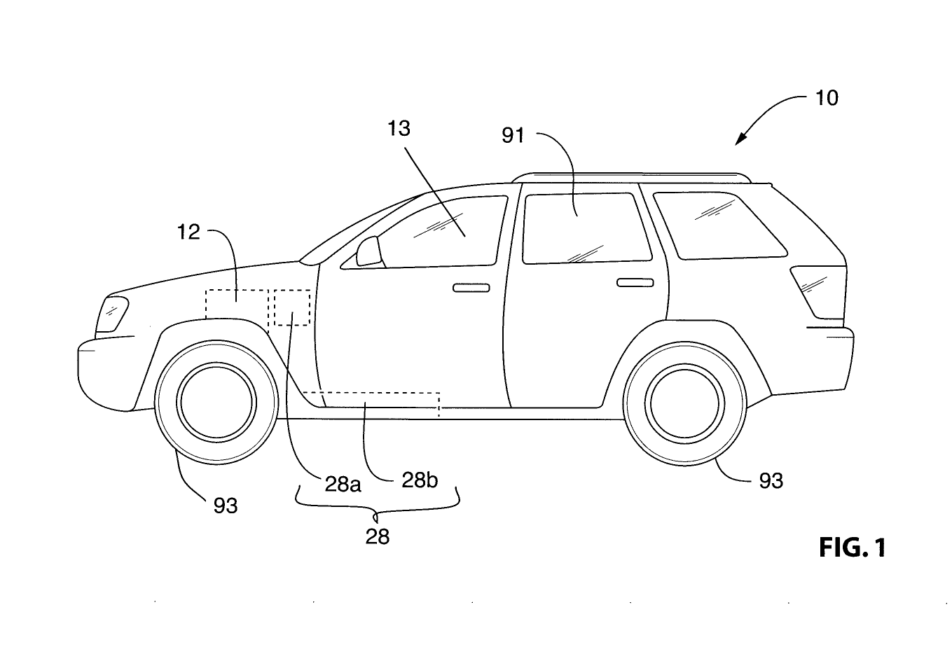

FIG. 1 depicts an electric vehicle 10. The term ‘electric vehicle’ as used herein denotes a vehicle that includes an electric traction motor (which may be referred to simply as an ‘electric motor’ for convenience). The electric vehicle 10 may also include an internal combustion engine, or alternatively it may lack an internal combustion engine. In embodiments wherein an internal combustion engine is provided, the engine may be operated simultaneously with the electric traction motor (parallel hybrid), or it may be operated only when the battery pack for the electric traction motor has been substantially depleted (or depleted to a minimum acceptable state of charge). In embodiments wherein the engine is provided, the function of the engine may be to propel the vehicle, to charge the battery pack, both propelling the vehicle and charging the battery pack, or for some other reason. Furthermore, the electric vehicle 10 may be any suitable type of vehicle, such as, for example, an automobile, a truck, an SUV, a bus, a van or any other type of vehicle. The vehicle 10 includes a body 91, a plurality of wheels 93, an electric traction motor 12 configured for driving at least one of the wheels 93, and a battery pack 28 configured for providing power to the electric traction motor 12. The battery pack 28 may be made up of multiple modules as shown at 28a and 28b, or alternatively may be made up of one module.

The electric traction motor 12 may be, for example, a high-voltage AC (alternating current) motor. The electric-traction motor 12 may be mounted in a compartment located forward of a passenger cabin 13 or at another suitable location.

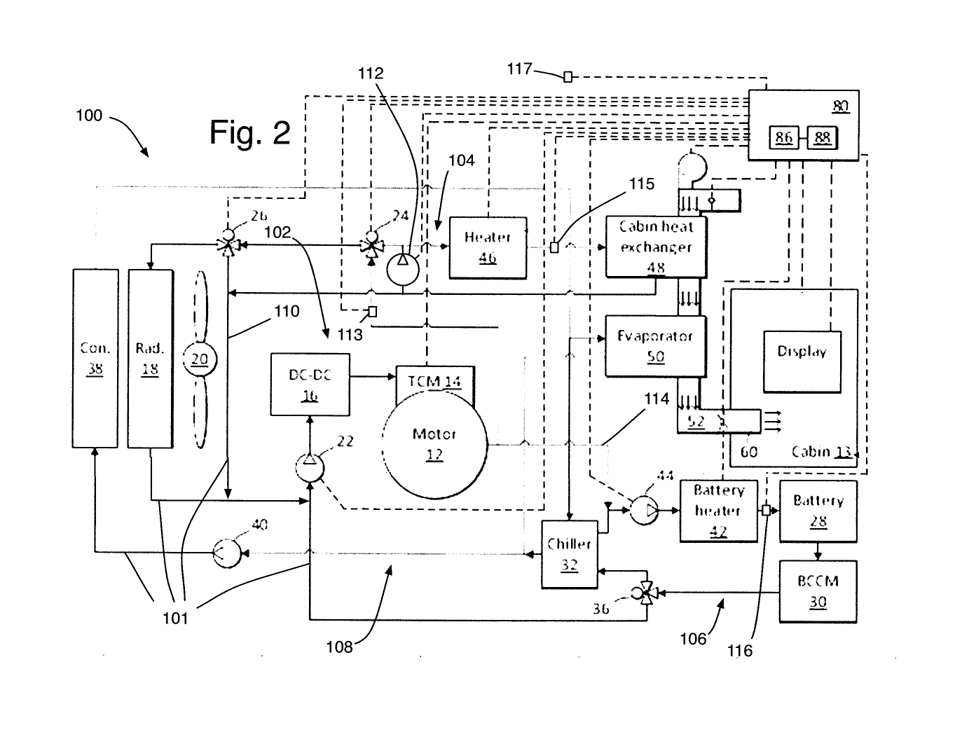

Reference is made to FIG. 2. As shown in FIG. 2, the vehicle 10 further includes a transmission control module (TCM) 14, and a DC-DC converter 16 which are electrically connected to each other. The transmission control module 14 may mount proximate to the electric-traction motor 12. The transmission control module 14 is part of a high-voltage electrical system of the vehicle 10 and is provided for controlling current flow to high-voltage electrical loads of the vehicle 10, such as the electric traction motor 12.

The DC-DC converter 16 receives electrical energy from the transmission control module 14. The DC-DC converter 16 is configured to convert current from high voltage to low voltage. The DC-DC converter 16 sends the low-voltage current to a low-voltage battery (not shown) that is used to power low-voltage loads of the vehicle 10. The low-voltage battery may operate on any suitable voltage, such as 12 volts or 42 volts.

The electric motor 12, the TCM 14, the DC-DC converter 16, the battery pack 28, and other components described herein represent thermal loads in the vehicle 10. To manage these thermal loads, a thermal management system 100 is provided, which is shown as a schematic illustration in FIG. 2. In FIG. 2, a plurality of fluid conduits 101 that are part of the thermal management system 100 are depicted in solid line. A selected number of electrical connections are depicted in FIG. 2 in dashed line. Not all electrical connections and fluid conduits are shown, for the sake of clarity.

In the exemplary embodiment shown in FIG. 2, the thermal management system 100 includes a plurality of coolant circuits including a motor circuit 102, a cabin heating circuit 104 and a battery circuit 106, to transport coolant through or around at least some of the thermal loads noted above, and to heat or cool the coolant as needed. In the embodiment shown in FIG. 2, the motor circuit 102, the cabin heating circuit 104 and the battery circuit 106 are all fluidically connected to each other so as to permit coolant to be transported from each of the circuits 102, 104, 106 to any other of the circuits 102, 104, 106. The thermal management system 100 further includes a refrigerant circuit 108 which permits the transport of refrigerant through or around at least some of the thermal loads noted above. The term ‘coolant’ denotes a liquid that is transported through and/or around components for controlling the temperature of those components. The coolant may in some instances draw heat from the components so as to cool the components, or, in other instances, the coolant may transfer heat contained therein to the components so as to heat the components.

The thermal loads that are managed in the motor circuit 102 include the electric traction motor 12, the transmission control module 14 and the DC-DC converter 16, which together make up a “motor circuit” thermal load. A radiator 18 is provided in the motor circuit 102 to dissipate heat in the coolant flowing therethrough. The radiator 18 may be positioned anywhere suitable, such as, for example, at the front of the vehicle 10 so as to receive a flow of air as the vehicle 10 is being driven. A fan 20 may be provided and positioned near the radiator 18 to assist in moving air across the radiator 18 so as to improve the heat dissipation capacity of the radiator 18. Coolant conduits connect the DC-DC converter 16, the transmission control module 14, the electric traction motor 12, and the radiator 18. A motor-circuit pump 22 may be located fluidically between the radiator 18 and from the DC-DC converter 16. The motor circuit pump 22 is configured to pump the coolant output from the radiator 18 into the DC-DC converter 16, and then through the transmission control module 14 and the electric traction motor 12 before returning to the radiator 18. A radiator-bypass valve 26 (which may, for example, be an electrically-powered diverter valve) is controllable to selectively permit or prevent coolant flow through the radiator. The radiator-bypass valve 26 may thus be positionable in a first position wherein coolant flow is directed through the radiator 18 prior to returning to the pump 22, and in a second position wherein coolant flow bypasses the radiator 18 and returns to the pump 22 via a radiator bypass conduit 110. It will be noted that when the valve 26 is in the first position, some coolant may still flow through the radiator-bypass conduit 110. Similarly when the valve 26 is in the second position, some coolant may still flow through the radiator 18. However in the first position more coolant flows through the radiator 18 than in the second position.

The cabin-heating circuit 104 is provided for managing a “cabin circuit” thermal load that, in the example embodiment shown, includes a cabin heater core 48. The cabin heater core 48 is a heat exchanger that permits heat exchange between the coolant flowing therethrough and an air flow flowing through an air duct 52 and into the cabin 13 via one or more outlets 60. A cabin circuit diverter valve 24 is provided for sending coolant from the motor circuit 102 into and through the cabin heating circuit 104 so that coolant that was heated by the motor circuit thermal load can be used to heat the cabin 13. In a situation where there is a demand for heat in the cabin (e.g. by a climate control system in the cabin 13) and where the coolant in the motor circuit 102 has been heated sufficiently by the motor circuit thermal load, the cabin circuit diverter valve 24 may be positioned in a first position wherein coolant is sent from the motor circuit 102 into the cabin heating circuit 104 for flow through the cabin heater core 48. The coolant subsequently flows back into the motor circuit 102, for example, through the radiator bypass conduit 110, and to the pump 22 so that it can be sent through the motor circuit thermal load again to be heated and again subsequently sent through the cabin heater core 48 to heat the air flow flowing into the cabin 13.

When the coolant from the motor circuit 102 is not sufficiently hot for use in heating the cabin 13, the cabin circuit diverter valve 24 is positioned in a second position in which coolant flow is prevented from the motor circuit 102 to the cabin circuit 104. In such a situation, when there is a demand for heat in the cabin a cabin circuit heater 46 is provided for heating coolant in the cabin heating circuit 104. The coolant that is heated by the heater 46 then flows through the cabin heater core 48 in order to heat the air flow flowing into the cabin 13. A cabin circuit pump 112 is provided to pump coolant through the cabin circuit 104 when the cabin circuit heater 46 is needed to help heat the cabin. A comparison of the temperatures of the coolant in the motor circuit 102 and the cabin heating circuit 104 may be carried out by a control system 80 receiving input from a motor circuit temperature sensor 113 which may be positioned downstream from the motor circuit thermal load and from a cabin heating circuit temperature sensor 115 that may be positioned upstream from the cabin heating circuit thermal load and downstream from the cabin circuit heater 46.

The cabin circuit heater 46 may be any suitable type of heater, such as a PTC heater which is a heater having an element with a positive temperature coefficient of resistance. The cabin circuit heater 46 may be, for example, a 6 KW heater, so as to provide it with the capability to heat the coolant in the cabin heating circuit 104 relatively quickly, ultimately to heat the cabin 13 relatively quickly.

The battery circuit 106 is provided for managing a “battery circuit” thermal load that, in the example embodiment shown, includes the battery pack 28 and a battery charge control module 30. The battery pack 28 may be any suitable type of battery pack, such as one made up of a plurality of lithium polymer cells. Maintaining the battery pack 28 within an operational temperature range increases the operating life of the battery pack.

The battery charge control module (BCCM) 30 is provided for controlling the charging of the battery pack 28. The battery charge control module 30 is configured to connect the vehicle 10 to an external-energy source (for example, a 110-volt source or a 220-volt source). The battery charge control module 30 is configured to provide current received from the external electrical source to any of several destinations, such as, the battery pack 28.

A battery circuit diverter valve 36 controls the flow of coolant from the motor circuit 102 to the battery circuit 106. When the battery pack 28 requires heat and the coolant in the motor circuit 102 is sufficiently hot, coolant can be directed from the motor circuit 102 to the battery circuit 106 through battery circuit feed conduit 114 by positioning the valve 106 in a first position, which permits coolant flow from the battery circuit 106 back to the motor circuit 102, e.g., to the inlet of the motor circuit pump 22, which in turn permits coolant to flow from the motor circuit 102 into the battery circuit 106 via the battery circuit feed conduit 114. When the battery pack 28 requires heat and the coolant in the motor circuit 102 is not sufficiently hot, a battery circuit heater 42 may be activated to heat coolant flowing to the battery pack 28, and the diverter valve 36 can be positioned in a second position 102 which directs coolant to flow back towards the battery circuit heater 42. The battery circuit heater 42 may be referred to as a battery pack heater 42 in embodiments wherein at least one of the components that make up the battery circuit thermal load is the battery pack 28. The battery circuit heater 42 may be any suitable type of heater, such as one or more 300 W glow plugs. In an example embodiment, there may be three glow plugs, which together provide 900 W of power.

A battery circuit pump 44 may be provided anywhere suitable, such as upstream from the battery circuit heater 42 so as to drive the flow of coolant about the battery circuit 106 particularly when the battery circuit diverter valve 36 is in the second position. In the example embodiment shown, the battery-circuit pump 44 pumps coolant through the battery circuit heater 42, through the battery pack 28 and the battery charge control module 30 through the battery-circuit diverter valve 36 and back to the inlet of the battery circuit pump 44.

A chiller 32 is shown in the battery circuit 106 upstream from the battery circuit pump 44 and may be used in some situations to cool the battery circuit thermal load. The chiller 32 forms part of the refrigerant circuit 108. The chiller 32 does not have refrigerant flowing therethrough in situations in which the battery pack 28 requires heating and is being heated. Other elements from the refrigerant circuit 108 include a compressor 40, a condenser 38, and an evaporator 50.

The above-described components of the vehicle 10, including in particular the battery circuit heater 42 and the cabin circuit heater 46, can be controlled by a control system 80. The control system 80 may be a single unit, as has been shown in FIG. 2. Alternatively, the control system 80 may be a complex distributed control system having multiple individual controllers connected to one another over a controller area network. The control system 80 may include (and is not limited to) a processor 86 and a memory unit 88 coupled together. The processor 86 is capable of reading and executing processor-executable instructions tangibly stored in the memory unit 88. The control system 80 further includes an input-output interface (not shown) for connecting to other components of the vehicle 10 to allow the processor 86 to communicate with such components. Such components may include, for example, the pumps 22, 112 and 44, the valves 24, 26 and 36 and one or more temperature sensors, such as temperature sensors 113, 115 and 116 for sensing the temperature of coolant in the three coolant circuits 102, 104 and 106 respectively, and an ambient temperature sensor shown at 117. The input-output interface may include a controller-area network bus (CAN bus) or the like. One such temperature sensor may be a battery circuit temperature sensor 116, which is positioned to sense the temperature of coolant in the battery circuit 104. In the embodiment shown, the temperature sensor 116 is positioned downstream of the battery circuit heater 42 and upstream from the battery circuit thermal load. By this positioning, the temperature sensor 116 can provide the control system 80 with a signal that directly represents the effect of the battery circuit heater 42 on the coolant passing therethrough.

The control system 80 is also electrically connected to other components of the vehicle 10 to monitor power consumption of the vehicle 10. For this purpose, in this example, the control system 80 is connected to the transmission control module 14, which distributes electrical power throughout the vehicle 10. In this way, the control system 80 can monitor electrical power consumed by each of the electrically powered components of the vehicle 10. In other examples, power consumed by a component of the vehicle 10 can be determined in other ways, such as by directly monitoring by the control system 80 of the power consumption at the component. Irrespective of the specific method of monitoring, the control system 80 may have access to the instantaneous power usage (e.g., in watts) of each of the electrically powered components of the vehicle 10.

A particular situation that can occur with the vehicle is as follows: The vehicle 10 is driven so that the battery pack 28 is at least partially depleted and is then parked and plugged in to an external source of electrical power, in conditions where the ambient temperature is very low (e.g. −20 degrees Celsius). The term ‘on-plug’ may also be used to denote when the vehicle is plugged in to an external source of electrical power. The term ‘off-plug’ may be used to denote when the vehicle is not plugged in to an external source of electrical power. The control system 80 may be programmed not to charge the vehicle 10 immediately when the vehicle 10 is plugged in due to a high cost of electricity at that time of day. Thus, the control system 80 may wait until later on in the evening to begin charging the battery pack 28 when the cost of electricity is typically lower. When the vehicle 10 is on-plug and the battery pack 28 is below a selected low temperature threshold, the battery pack 28 can be damaged if suddenly exposed to a charging current. To avoid such a scenario the control system 80 may heat the battery pack 28 in advance of charging the battery pack 28 to ensure that the battery pack 28 is above the low temperature threshold when charging of the battery pack 28 is initiated. Because the vehicle 10 is typically not running (i.e. the vehicle 10 is off) when it is put on-plug, the control system 80 cannot draw waste heat from the motor circuit 102 to heat the battery pack 28. Thus, the control system 80 may use the battery circuit heater 42 to heat the battery pack 28. For example, the control system 80 may optionally position the battery circuit diverter valve 36 in the second position so as to isolate the battery circuit 106 from the motor circuit 102, and may activate the battery circuit heater 42 and the battery circuit pump 44 so as to circulate coolant through the battery circuit 106 and to heat the coolant.

The control system 80 may use any type of control scheme when operating the battery circuit heater 42 to bring the battery pack 28 at least to the low temperature threshold. The control scheme may be a closed-loop control scheme based on bringing the battery pack coolant inlet temperature (i.e. the temperature of coolant entering the battery pack 68) to a selected value and by verifying whether the battery pack 28 has reached the low temperature threshold. During this process, the control system 80 checks whether the battery circuit heater 42 is operating properly (e.g. by checking the current to the battery circuit heater 42, or by checking the temperature recorded by the battery circuit temperature sensor 116).

In a situation where the control system 80 detects a failure of the battery circuit heater 42, the control system 80 may respond to such a failure by activating the cabin circuit heater 46 and thermally connecting the cabin circuit heater 46 to the battery pack 28. Thermally connecting the cabin circuit heater 46 to the battery pack 28 in the example embodiment shown in FIG. 2 may entail heating coolant passing through the cabin circuit heater 46 and fluidically connecting the cabin circuit heater 46 to the battery pack 28. For example, the control system 80 may position the cabin circuit diverter valve 24 in the first position, thereby permitting coolant to pass from the cabin circuit 104 to the motor circuit 102, and the control system 80 may position the battery circuit diverter valve 36 in the first position, thereby permitting coolant to pass from the motor circuit 102 to the battery circuit 106. Thus, by positioning the cabin circuit diverter valve 24 and the battery circuit diverter valve 36 in their respective first positions, the cabin circuit 104, the motor circuit 102 and the battery circuit 106 are all in fluidic communication with each other. The control system 80 may operate at least one of the pumps 22, 112, 44 (and possibly all three pumps 22, 112, 44) to drive circulation of the coolant through the three circuits 102, 104, 106. Thus, heat that is generated at the cabin circuit heater 46 can reach the battery pack 28 to heat the battery pack 28. In at least some embodiments, the battery pack 28 can be heated sufficiently to at least reach the low temperature threshold so that the battery pack 28 can be charged with little risk of low-temperature-related damage. In some embodiments, it is possible that the cabin circuit heater 46 may not be capable of heating the battery pack 28 sufficiently to reach the low temperature threshold, however whatever heating is provided by the cabin circuit heater 46 to the battery pack 28 may be sufficient to at least reduce the risk of low-temperature-related damage to the battery pack 28 during charging.

In broad terms, the control system 80 uses a second thermal load heater (i.e. a heater that is not the battery circuit heater 42) which is used under normal circumstances for heating a second thermal load, (i.e. a thermal load that is not the battery pack) to heat the battery pack 28 in response to a failure of the battery circuit heater 42. Thus, in an example described above, the second thermal load is the cabin circuit thermal load, which includes the cabin heater core 48, and the second thermal load heater is the cabin circuit heater 46.

The cabin circuit heater 46 is thus just one example of a second thermal load heater that could be used under normal circumstances for heating a second thermal load, but which can be used to heat the battery pack 28 if needed. In other embodiments a heater that is intended for some other second thermal load could be used to heat the battery pack 28 in the event of a failure of the battery circuit heater 42 if needed. An example of another heater that could be the second thermal load heater is a seat warmer, which may optionally be provided in the vehicle 10.

Also, while the cabin circuit heater 46 was thermally connected to the battery pack by way of the coolant circuits 102, 104 and 106, it is possible for some embodiments to provide a different way of thermally connecting a second thermal load heater with the battery pack 28. For example, the cabin circuit heater 46 may be positioned proximate to a conduit upstream from the battery pack 28. The cabin circuit heater 46 may be capable of selectively conducting heat to the coolant in the battery circuit 106 by selectively connecting a thermally conductive member (e.g. a metallic member) between the heating element (not shown) in the cabin circuit heater 46 and the coolant in the battery circuit 106. Thus, the cabin circuit heater 46 can heat the coolant in the battery circuit 106 by direct thermal conduction. In yet another embodiment, the cabin circuit heater 46 can be selectively connected to the battery pack 28 itself via a thermally conductive (e.g. metallic) member so that the cabin circuit heater 46 can heat the battery pack 28 itself by direct thermal conduction.

While the battery pack heater 42 shown in FIG. 2 was described as being configured to heat the battery pack 28 by heating coolant in a battery circuit that was then transported to the battery pack 28, it is alternatively possible to provide a battery pack heater that has a heating element that directly contacts the battery pack 28 to heat the battery pack 28 directly.

For greater certainty, regardless of how the second thermal load heater 46 is configured to heat the battery pack 28, the battery pack heater 42 may heat the battery pack 28 via coolant, or via direct contact, or via any other suitable method and structure. Analogously, regardless of how the battery pack heater 42 is configured to heat the battery pack 28, the second thermal load heater 46 may heat the battery pack 28 via coolant, or via direct contact, or via any other suitable method and structure.

While a plurality of coolant circuits are shown in FIG. 2, it is alternatively possible to provide an embodiment wherein the thermal management system circulates coolant in a single circuit instead that may include a thermal load that includes the battery pack 28 and optionally such components as the electric motor 12, the TCM 14, the DC-DC converter 16 and the cabin heater core 48, the battery pack heater 42 upstream from the battery pack 28. The second thermal load heater may or may not be configured to heat coolant in that single circuit, or may be configured to heat the battery pack 28 some other way (e.g. by direction thermal conduction).

In the example embodiment shown in FIG. 2, it will be noted that the cabin circuit heater 46 has a power output that is greater than a power output of the battery circuit heater 42 (6 KW vs. 900 W). In some embodiments, the second thermal load heater 46 may have a greater power output than the battery circuit heater 42, but by a different (e.g. smaller) ratio than the aforementioned ratio of 6 KW to 900 W. When using the cabin circuit heater 46 to heat the battery pack 28, a different control scheme is used by the control system 80 to ensure that the battery pack is heated without sustaining damage. For example, when heating the battery pack using the cabin circuit heater 46, the control system 80 may take inputs relating to ambient temperature (e.g. from ambient temperature sensor 117), relating to coolant temperature in the battery circuit 106 (e.g. from battery circuit temperature sensor 116) and relating to the temperature of the battery pack 28. The battery pack 28 may be equipped with a plurality of internal temperature sensors. For example, a temperature sensor may be provided for each cell in the battery pack 28.

The inputs relating to the temperature of the battery pack 28 may include the average temperature of the battery pack, and also the delta T across the battery pack 28. The delta T is the difference between the temperature of the hottest cell in the battery pack 28 and the coldest cell in the battery pack 28. In general, when heated coolant is sent through the battery pack 28 in order to heat the battery pack 28, the coolant will progressively drop in temperature as it releases heat to the cells as it passes through the battery pack 28. Specifically, the coolant heats the cells closest to the coolant inlet of the battery pack 28 to the highest temperatures and heats the remaining cells to progressively lower temperatures as the coolant passes through the battery pack 28. As a result, there is a temperature gradient across the battery pack 28. It is, however, advantageous to keep the temperature gradient relatively small for several reasons. One reason is that the temperature of the cells directly impacts their resistance to electrical current. The larger the temperature gradient across the battery pack 28, the larger the variation in electrical resistance there is in the cells in the battery pack 28. The resistance of a cell directly impacts the amount of charge that the cell will receive from the external power source. Thus, cells that are farther above the low temperature threshold (without being too far above it), will charge faster (and thus increase in voltage faster) than cells that are closer to the low temperature threshold. As a result, the battery pack 28 will experience a relatively large imbalance in the voltages of the cells when there is a relatively large temperature gradient across the battery pack 28, which will cause the battery pack 28 to undergo a cell balancing step earlier on (and possibly more often) during the charging process than might have occurred if there was a relatively small temperature gradient across the battery pack 28. An example of a maximum acceptable temperature gradient across the battery pack 28 (as represented by delta T) may be, for example, about 10 degrees Celsius, or may be, for example, about 5 degrees Celsius.

The control system 80 may use the above noted inputs in the following way when operating the cabin circuit heater 46 to heat the battery pack 28. Prior to permitting charging of the battery pack 28, the control system 80 checks the average battery pack temperature. If the average battery pack temperature is too low (i.e. below the low threshold temperature, which may be, for example, 10 degrees Celsius), the control system 80 will prevent charging from the external power source.

The control system 80 may use a closed-loop control algorithm (e.g. a PID control algorithm) to set a duty cycle for the cabin circuit heater 46 in order to reach and maintain a target coolant inlet temperature for the battery pack, which is measured using the battery circuit temperature sensor 116. Thus, the signals from the battery circuit temperature sensor 116 provide the closed-loop feedback for the control algorithm. The control algorithm used when running the second thermal load heater 46 need not be the same as the control algorithm used when running the battery circuit heater. For example, if the control algorithm used for the heater 46 is a PID control algorithm, the control algorithm used for the battery circuit heater 42 need not be a PID control algorithm. In embodiments wherein it is a PID control algorithm, it need not have the same values for P, I and D as those used in the PID control algorithm for using the heater 46 to heat the battery pack 28.

The selection of the target coolant inlet temperature may be based on several factors. For example, the target coolant inlet temperature is set at least in part based on the low threshold temperature of the battery pack 28. In the example noted above where the low threshold temperature for the battery pack 28 is about 10 degrees Celsius, the target coolant inlet temperature may be set to about 30 degrees Celsius in some circumstances.

Another factor that may influence the selection of the target coolant inlet temperature is the delta T across the battery pack (which represents the temperature gradient across the battery pack). When the control system 80 receives input indicating that the delta T is approaching or exceeds the maximum acceptable temperature gradient, the control system 80 may adjust the target coolant inlet temperature (e.g. downwards) to a selected value that reduces the amount of heat that is imparted by the coolant to the hottest cells of the battery pack 28 while still heating the other cells in the battery pack 28.

Another factor that affects the selection of the target coolant inlet temperature is the temperature of the hottest cell in the battery pack 28. This can be determined easily based on the average temperature and the delta T (e.g. by adding half of the value of delta T to the average temperature). It will be noted that there is a maximum acceptable cell temperature for the cells of the battery pack 28. If any of the cells are heated to temperatures beyond this maximum acceptable cell temperature, the operating life of the cells degrades more rapidly and their performance and capacity are reduced, as compared to cells that are kept cooler. The maximum acceptable cell temperature may be, for example, about 40 degrees Celsius, or in some cases about 50 degrees Celsius.

If the heated coolant has driven up the temperature of the hottest cells in the battery pack 28 to temperatures that reach the maximum acceptable cell temperature, the control system 80 may be programmed to reduce the duty cycle of the cabin circuit heater 46 (effectively reducing the target coolant inlet temperature) in an effort to prevent any further increase in temperature of those hottest cells. The control system 80 may be provided with multiple maximum acceptable cell temperatures and a lookup table to determine what action to take (e.g. what target coolant inlet temperature to use, or what duty cycle to use for the cabin circuit heater 46). For example, at 40 degrees Celsius, the control system 80 may reduce to some non-zero value the duty cycle of the cabin circuit heater 46. If the hottest cells reached 50 degrees Celsius, however, the control system 80 may deactivate the cabin circuit heater 46 altogether in an effort to reduce the temperature of those hottest cells.

When initially activating the cabin circuit heater 46, a factor that impacts the selection of an initial duty cycle for the cabin circuit heater 46 may be the ambient temperature. For example, if the ambient temperature is −20 degrees Celsius, the control system 80 may select a duty cycle that is relatively higher (e.g. 50% so as to achieve 3 KW of power from the cabin circuit heater 46), whereas if the ambient temperature is 0 degrees Celsius, the control system 80 may select an initial duty cycle that is relatively lower (e.g. about 16% so as to achieve about 1 KW of power from the cabin circuit heater 46).

While the inputs to the control system 80 are described above as including the average battery pack temperature and the delta T, it is alternatively possible to provide more detailed information to the battery pack 28, such as the temperatures of all the cells in the battery pack 28.

Any of the adjustments described above that the control system 80 makes to the target coolant inlet temperature may be made based, for example, on formulas, or, for example, on lookup tables for the various inputs described above. The specific values used for the lookup tables may be selected based on empirical testing of a test vehicle, based on the specific properties of the thermal management system 100, based on the specific properties of the battery pack 28, specific safety factors used in the vehicle design, and on other factors, as will be understood by a person skilled in the art.

It may be appreciated that the assemblies and modules described above may be connected with each other as may be required to perform desired functions and tasks that are within the scope of persons of skill in the art to make such combinations and permutations without having to describe each and every one of them in explicit terms.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thermal management system for a vehicle having an electric traction motor for moving the vehicle, and a battery pack configured to provide power for driving the electric traction motor, the thermal management system comprising:
a battery pack heater configured to transfer heat to the battery pack;
a second thermal load heater configured to transfer heat to a second thermal load, wherein the second thermal load heater is selectively thermally connectable to the battery pack to transfer heat from the second thermal load heater to the battery pack; and
a control system, wherein, when the vehicle is connected to an external energy source and the battery pack is at sufficiently low temperature, the control system is configured to control the temperature of the battery pack by activating the second thermal load heater and thermally connecting the second thermal load heater to the battery pack in response to a failure of the battery pack heater.

2. The thermal management system of claim 1, wherein the second thermal load includes a heater core for heating air for a passenger cabin.

3. The thermal management system of claim 1, further comprising a plurality of fluid conduits configured to transport coolant to the battery pack and to the second thermal load, wherein the coolant is heatable by the battery pack heater to transfer heat to the battery pack and wherein the coolant is heatable by the second thermal load heater to transfer heat to the second thermal load and to the battery pack.

4. The thermal management system of claim 3, further comprising:
a motor circuit that is controllable to transport coolant through the electric traction motor;
a cabin circuit that is controllable to transport coolant through a cabin heater core; and
a battery circuit that is controllable to transport coolant through the battery pack, wherein the battery pack heater forms part of the battery circuit,
wherein the second thermal load heater forms part of at least one of the cabin circuit and the motor circuit, and wherein the thermal management system further includes a plurality of valves that are controllable by the control system to selectively permit a flow of coolant between the motor circuit and the cabin circuit and to selectively permit a flow of coolant between the motor circuit and the battery circuit.

5. The thermal management system of claim 1, wherein the second thermal load heater has a power output that is greater than a power output of the battery pack heater.

6. A vehicle, comprising:
a body;
a plurality of wheels;
an electric traction motor configured to drive at least one of the wheels;
a battery pack configured to provide power to drive the electric traction motor;
a battery pack heater configured to transfer heat to the battery pack;
a second thermal load heater configured to transfer heat to a second thermal load, wherein the second thermal load heater is selectively thermally connectable to the battery pack to transfer heat from the second thermal load heater to the battery pack; and
a control system, wherein, when the vehicle is connected to an external energy source and the battery pack is at sufficiently low temperature, the control system is configured to control the temperature of the battery pack by activating the second thermal load heater and thermally connecting the second thermal load heater to the battery pack in response to a failure of the battery pack heater.

7. The vehicle of claim 6, wherein the second thermal load includes a heater core for heating air for a passenger cabin.

8. The vehicle of claim 6, further comprising a plurality of fluid conduits configured to transport coolant to the battery pack and to the second thermal load, wherein the coolant is heatable by the battery pack heater to transfer heat to the battery pack and wherein the coolant is heatable by the second thermal load heater to transfer heat to the second thermal load and to the battery pack.

9. The vehicle of claim 6, further including a thermal management system having a motor circuit that is controllable to transport coolant through the electric-traction motor, a cabin circuit that is controllable to transport coolant through a cabin heater core, and a battery circuit that is controllable to transport coolant through the battery pack, wherein the battery pack heater forms part of the battery circuit, wherein the second thermal load heater forms part of at least one of the cabin circuit and the motor circuit, and wherein the thermal management system further includes a plurality of valves that are controllable by the control system to selectively permit a flow of coolant between the motor circuit and the cabin circuit and to selectively permit a flow of coolant between the motor circuit and the battery circuit.

10. The vehicle of claim 6, wherein the second thermal load heater has a power output that is greater than a power output of the battery pack heater.

11. A method for controlling the temperature of a battery pack in a vehicle having an electric traction motor, comprising:
a) heating the battery pack with a battery pack heater while the vehicle is connected to an external energy source; and
b) heating the battery pack with a second thermal load heater that is positioned to heat a second thermal load in response to detecting a failure of the battery pack heater.

12. The method as claimed in claim 11, wherein step b) includes:
c) selecting a duty cycle for the second thermal load heater based on ambient temperature, coolant inlet temperature for coolant entering the battery pack and a temperature associated with the battery pack.
